(19) United States
(12) Patent Application Publication
(10) Pub. No.: US 2025/0026621 A1
(43) Pub. Date: Jan. 23, 2025

(54) Clamping Apparatus

(71) Applicant: Edward Tygard, McMurray, PA (US)

(72) Inventor: Edward Tygard, McMurray, PA (US)

(21) Appl. No.: 18/775,992

(22) Filed: Jul. 17, 2024

Related U.S. Application Data
(60) Provisional application No. 63/527,391, filed on Jul. 18, 2023.

(51) Int. Cl. B66F 9/18; B66C 1/54

(52) U.S. Cl. CPC B66F 9/183; B66C 1/54

(57) ABSTRACT

A clamping apparatus includes a frame and two or more clamping arms supported by the frame for movement into and out of contact with a load. An internal support is supported by the frame for reinforcing inner walls of a cavity in the object to be lifted. The internal support may be supported by the frame for vertical movement with respect to the frame so that when the internal support is not needed, it can be raised above the load. The internal support may passively reinforce a cavity, or it may be equipped with movable reinforcing portions which can be moved into and out of contact with the walls of the cavity which is to be reinforced. The frame of the clamping apparatus may have an opening in which the lower end of the internal support can be received over all or most of the depth of the lower end.

### REFERENCE TO RELATED APPLICATIONS

This application claims the benefit of U.S. Provisional Application No. 63/527,391 filed on Jul. 18, 2023, the disclosure of which is incorporated by reference.

### BACKGROUND OF THE INVENTION

### Field of the Invention

This invention relates to a clamping apparatus for use in simultaneously lifting one or more layers of objects by grasping the sides of one or more of the layers.

### Description of the Related Art

Clamping apparatuses have been developed which can lift one or more entire layers of objects at a time from a pallet or other support surface and move the one or more layers to another location, such as to another pallet. These devices are sometimes referred to as layer pickers.

Frequently, objects stacked on a pallet in layers cannot be formed into solid layers of prescribed dimensions due to the dimensions of the individual objects and the area of the pallet. In such cases, the objects may be formed into layers containing cavities. For example, it is common to stack cases or packs of canned soft drinks on a rectangular pallet in a configuration in which each layer in the stack contains a cavity at its center, with the cavity extending over the entire height of the stack. A typical 12-pack of soft drinks holds 12 cans arranged in an array of 3 cans by 4 cans, so in an example in which each layer in a stack contains sixteen 12-packs, the cavity is square and measures 2 cans wide and 2 cans long. As another example, 12-packs of canned soft drinks are frequently stacked in elongated rectangular layers each containing eighteen 12-packs, with each layer having an elongated rectangular cavity at its center measuring 2 cans wide and 4 cans long.

When pressure is applied to the outer surfaces of a layer containing such a cavity by a clamping apparatus in order to lift the layer, the cavity may allow shifting of the objects in the layer, which is undesirable, since the shifting may result in the outer surface of the stack becoming irregular so that the clamping arms of the clamping apparatus cannot be pressed flat against the outer surface of the stack. Furthermore, because of the presence of the cavity, the stresses in locations where a corner of one object in the layer abuts against the side of another object in the layer are increased, possibly resulting in deformation of the objects in the layer.

U.S. Pat. No. 6,003,917 entitled “Clamping Apparatus”, the disclosure of which is incorporated by reference, discloses a clamping apparatus equipped with an internal support which is capable of supporting the inner walls of a cavity in a layer of objects so as to reduce or prevent shifting of objects in the layer when the layer is being grasped by the clamping apparatus. The internal support is supported by a frame of the clamping apparatus so as to be able to move vertically with respect to the frame. When the clamping apparatus is positioned over a load containing a cavity, the internal support can be lowered together with the frame to a height at which the internal support can reinforce the cavity. When the clamping apparatus is positioned over a load which does not contain a cavity, the internal support can translate upwards with respect to the frame and rest atop the top surface of the load without interfering with the operation of the clamping apparatus.

However, when the internal support is resting on the top surface of a load, the lower end of the internal support may extend below the bottom surface of the frame of the clamping apparatus and take up space which could be used to house an additional layer in the load, thereby limiting the capacity of the clamping apparatus.

### SUMMARY OF THE INVENTION

The present invention provides a clamping apparatus which is capable of grasping one or more layers of objects and which has an internal support for reinforcing inner walls of a cavity in one or more of the layers.

The present invention also provides a method of using a clamping apparatus equipped with an internal support.

According to one form of the present invention, a clamping apparatus includes a frame and a plurality of clamping arms supported by the frame for movement with respect to the frame between an open and closed position so as to be able to grasp and release a load. An internal support for insertion into a cavity in a layer of objects within the load to be grasped by the clamping arms is supported by the frame between the clamping arms for vertical movement with respect to the frame. The internal support can be lowered with respect to the frame to a position in which the internal support can be inserted into a cavity in a load and reinforce inner walls of the cavity to prevent shifting and deformation of objects adjoining the cavity. The internal support can also be raised with respect to the frame to a position in which the lower end of the internal support is received within an opening in the frame over all or most of the depth of the lower end of the internal support so that the internal support does not interfere with a load held by the clamping apparatus or limit the capacity of the clamping apparatus.

According to another form of the present invention, a method of operating a clamping apparatus includes raising an internal support of the clamping apparatus to a position in which a lower end of the internal support is received within an opening in a frame of the clamping apparatus over all or most of the depth of the lower end of the internal support.

A clamping apparatus according to the present invention may include a holding mechanism for holding an internal support in a raised position with respect to a frame of the clamping apparatus when it is not necessary to use the internal support to reinforce a cavity in a layer of objects to be lifted, such as when no cavity is present in a load.

A clamping apparatus according to the present invention may include a damping mechanism for damping downwards movement of an internal support with respect to a frame of the clamping apparatus when a holding mechanism of the clamping apparatus releases the internal support.

Accordingly, in another form of the present invention, a clamping apparatus includes a frame and a plurality of clamping arms supported by the frame for movement with respect to the frame between an open and closed position so as to be able to grasp and release a load. An internal support for insertion into a cavity in a layer of objects within the load to be grasped by the clamping apparatus is supported by the frame of the clamping apparatus for vertical movement with respect to the frame. The clamping apparatus further includes a holding mechanism for holding the internal support against downwards vertical movement with respect to the frame of the clamping apparatus when it is not necessary to use the internal support to reinforce a cavity in a layer of objects to be lifted.

A holding mechanism may be manually controlled by a user of the clamping apparatus, or it may be automatically controlled. In one form of the present invention, a holding mechanism is automatically actuated to prevent downwards movement of the internal support with respect to the frame of the clamping apparatus when the internal support is in a prescribed vertical position with respect to the frame of the clamping apparatus. In another form of the present invention, a holding mechanism is automatically actuated to prevent downwards vertical movement of the internal support with respect to the frame of the clamping apparatus when the clamping arms of the clamping apparatus are in a closed position.

According to another form of the present invention, a method of operating a clamping apparatus includes sensing the vertical position of an internal support with respect to a frame of the clamping apparatus and automatically operating a holding mechanism to hold the internal support against downwards movement with respect to the frame of the clamping apparatus when the sensed position is a prescribed vertical position with respect to the frame.

According to yet another form of the present invention, a method of operating a clamping apparatus includes sensing whether clamping arms of the clamping apparatus are in an open or closed position, automatically operating a holding mechanism to hold an internal support of the clamping apparatus against downwards movement with respect to the frame of the clamping apparatus when the clamping arms are in a closed position and automatically releasing the internal support with the holding mechanism when the clamping arms are in an open position.

The lower end of the internal support may have an outer surface which passively reinforces inner walls of a cavity, or the lower end may be equipped with movable reinforcing members which can be moved from a retracted position into an extended position in which the reinforcing members reinforce the inner walls of a cavity. Examples of movable reinforcing members which are suitable for use in a clamping apparatus according to the present invention are disclosed in U.S. Pat. No. 6,003,917.

The clamping arms can move with respect to the frame of the clamping apparatus between open and closed positions by any type of motion, such as by translation, rotation, or a combination of translation and rotation.

A clamping apparatus according to the present invention is particularly suitable for mounting on a forklift. However, it can be used with any mechanism capable of raising and lowering the clamping apparatus together with a load held by the clamping apparatus, such as a crane, a boom, a davit, or a robotic arm.

A clamping apparatus according to the present invention is particularly suited for lifting square or elongated rectangular layers of objects such as cases, trays, or boxes containing beverages or food items. However, the present invention is not restricted to use with any particular type or shape of object, and it can be used to lift bricks, lumber, barrels, bottles, and other cylindrical objects, bales, stacks of paper products, and boxes, cartons, and packages of various types of merchandise, to give but a few examples. The object or objects to be lifted need not be arranged in layers, and the clamping apparatus can be used to lift a single object, such as a single box. Thus, the present invention can be used with virtually any objects which can be grasped by forces applied from a plurality of sides.

### BRIEF DESCRIPTION OF THE DRAWINGS

FIG. 1 is a cutaway side elevation of an embodiment of a clamping apparatus according to the present invention with the clamping arms of the clamping apparatus in an open position and an internal support in a lowered position.

FIG. 2 is a cutaway side elevation of the embodiment of FIG. 1 showing the clamping apparatus with the internal support inserted into a cavity in a load disposed atop a pallet.

FIG. 3 is a top plan view of the central portion of the embodiment of FIG. 1 showing an example of a holding mechanism for holding the internal support in a raised position in a latched state.

FIG. 4 is a top plan view similar to FIG. 3 showing the holding mechanism of FIG. 3 in an unlatched state.

FIG. 5 is an exploded axonometric view of the internal support in the embodiment of FIG. 1.

FIG. 6 is a cutaway side elevation of the embodiment of FIG. 1 mounted on a forklift and positioned above a load with the internal support in a raised position.

FIG. 7 is a cutaway side elevation of a portion of the embodiment of FIG. 1 showing an example in which the bottom portion of the internal support can be received in the opening over the entire depth of the bottom portion.

FIG. 8 is a cutaway side elevation of a portion of the embodiment of FIG. 1 showing an example in which the bottom portion of the internal support can be received in the opening in the frame over most of but not the entire depth of the bottom portion.

FIG. 9 is a cutaway side elevation of the embodiment of FIG. 1 with the internal support in a lowered position and resting on the top surface of a load which does not contain a cavity.

FIG. 10 is a cutaway side elevation of the embodiment of FIG. 1 with the internal support in a raised position and resting on the top surface of a load which does not contain a cavity.

FIG. 11 is a schematic elevation of a holding mechanism which can hold the internal support at multiple vertical positions with respect to the frame of the clamping apparatus.

FIGS. 12 and 13 are schematic elevations of a holding mechanism which can hold the internal support against downwards vertical movement with respect to the frame of the clamping apparatus while permitting upwards vertical movement.

FIG. 14 is a schematic elevation of a damping mechanism for controlling the rate of descent of the internal support with respect to the frame of the clamping apparatus when the internal support is not being held by the holding mechanism.

FIG. 15 is a schematic diagram of a control arrangement for enabling an operator of the clamping apparatus to control a holding mechanism by remote control.

FIG. 16 is a schematic illustration of a control arrangement which can automatically activate a holding mechanism when the internal support is at a prescribed height with respect to the frame of the clamping apparatus.

FIG. 17 is a schematic illustration of a control arrangement which can automatically activate a holding mechanism when the clamping arms of the clamping apparatus are in a closed position.

FIG. 18 is a schematic illustration of a control arrangement which enables a user to select among multiple control modes of the holding mechanism.

FIG. 19 is a schematic plan view of an example of a common arrangement of trays for soft drink bottles disposed atop a pallet in a layer containing a cavity.

FIG. 20 is a schematic cutaway elevation of an example of an arrangement for raising and lowering the internal support with a powered lifting device.

### DESCRIPTION OF EMBODIMENTS

Below, embodiments of a clamping apparatus according to the present invention will be described while referring to the accompanying drawings.

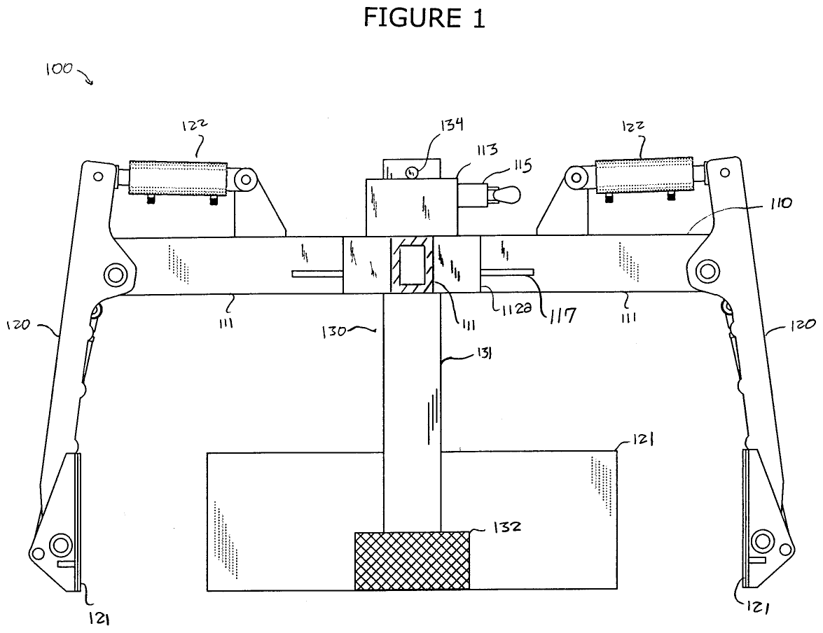

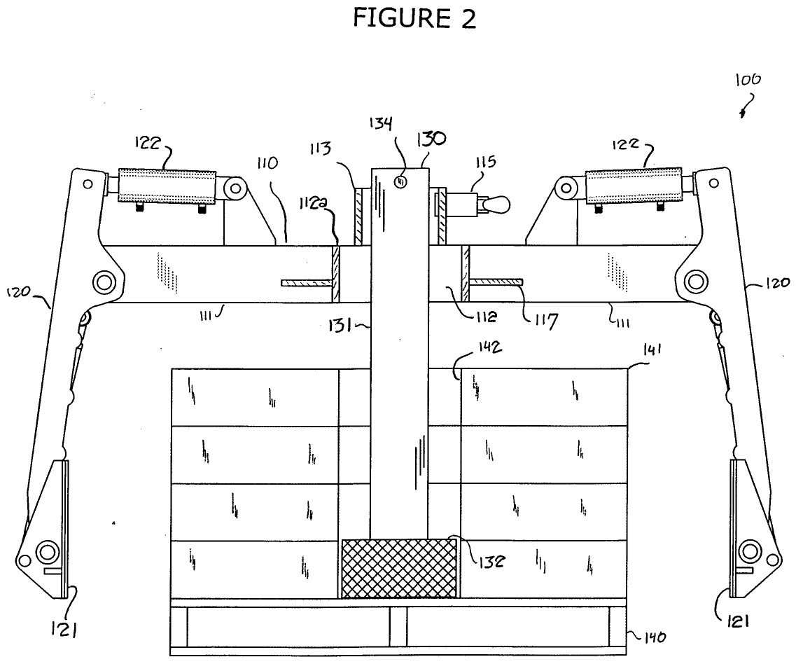

FIGS. 1-6 illustrate an embodiment of a clamping apparatus 100 according to the present invention. FIG. 1 illustrates the clamping apparatus 100 as it would appear when resting on a floor or other support surface, and FIG. 2 illustrates the clamping apparatus 100 positioned above a load 141 disposed on a pallet 140. The illustrated load 141 comprises a plurality of layers having an internal cavity 142 (shown in FIG. 2) which in this case extends over the entire height of the load 141, although it is possible for an internal cavity 142 in a load to extend over only a portion of the height of the load 141.

As shown in these figures, the clamping apparatus 100 includes a rigid frame 110 and a plurality of clamping arms 120 pivotably mounted on the frame 110 for movement with respect to the frame 110 between an open and closed position. This embodiment includes four clamping arms 120, although some of the clamping arms 120 have been omitted from the drawings for clarity. While the clamping apparatus 100 will typically include four clamping arms 120 arranged in two opposing pairs, it is possible for the clamping apparatus 100 to have fewer than four clamping arms 120, such as a single pair of opposing clamping arms when it is sufficient to grasp a load from only two sides.

Each of the clamping arms 120 can be pivoted with respect to the frame 110 between an open position in which a contact portion 121 of the clamping arm 120 is spaced from a side of a load and a closed position in which the contact portion 121 is pressed again a side of the load by suitable actuators, such as hydraulic cylinders 122 mounted on the frame 110. The overall structure of the frame 110, the clamping arms 120, and the hydraulic cylinders 122 in this embodiment is basically the same as that of a clamping apparatus disclosed in U.S. Pat. No. 7,537,427 entitled “Clamping Apparatus”, the disclosure of which is incorporated by reference. Accordingly, a detailed description of these components of the clamping apparatus 100 will be omitted.

Instead of the clamping apparatus 100 being of the type having clamping arms 120 which can pivot with respect to a frame, it is possible for the clamping apparatus to be of a type having clamping arms which can translate with respect to the frame between an open and closed position. An example of such a clamping apparatus is described in above-mentioned U.S. Pat. No. 7,537,427.

The frame 110 is not restricted to one having any particular shape. In the present embodiment, the frame 110 is a generally cross-shaped member including four horizontal legs 111 each extending outwards from the center of the frame 110 at right angles with respect to the adjoining legs 111. However, the frame 110 may have a variety of other shapes, such as the shape of a circle, a square, a rectangle, or other curved or polygonal shape.

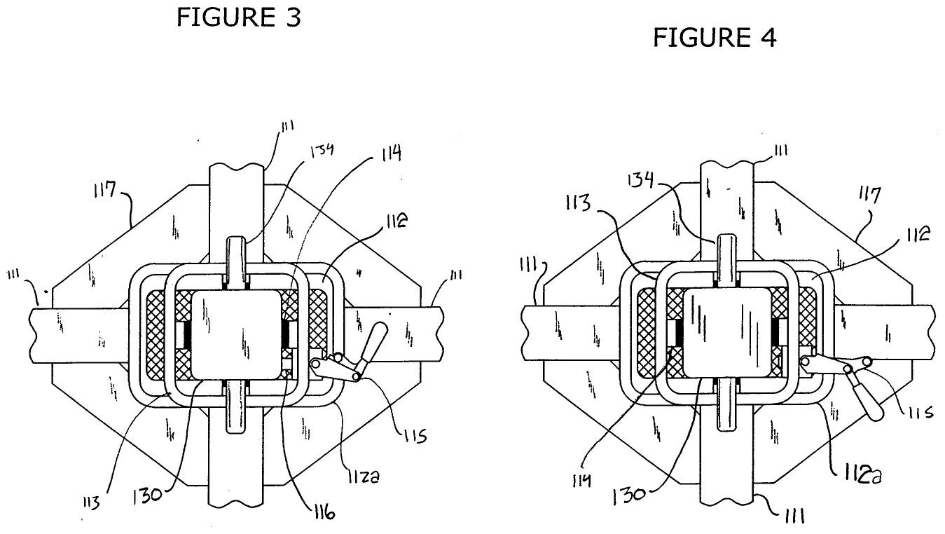

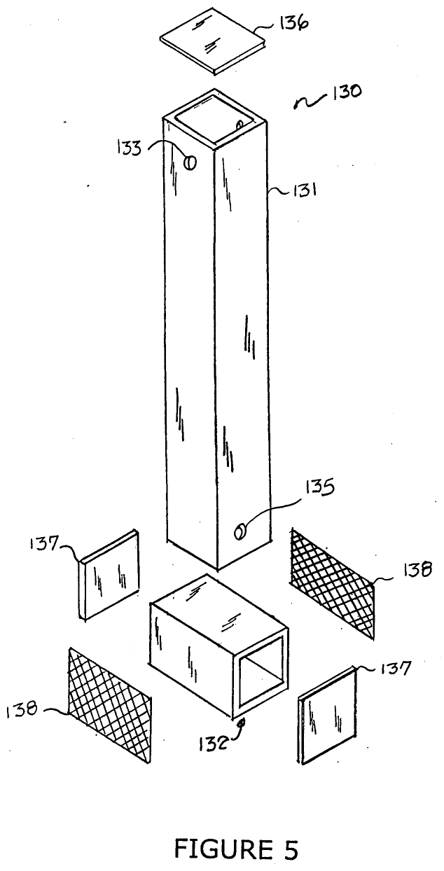

An opening 112 for receiving the lower end of an internal support 130 is formed at the center of the frame 110. In the present embodiment, the opening 112 is defined by a rigid box-shaped member 112a formed from a short length of steel tubing to which each of the legs 111 of the frame 110 is rigidly secured by welding, for example. As shown in FIGS. 3 and 4, which are top plan views of the central portion of the clamping apparatus 100, stiffeners 117 may be secured between adjoining legs 111 and the box-shaped member 112a defining the opening 112 of the frame 110 to reinforce the legs 111.

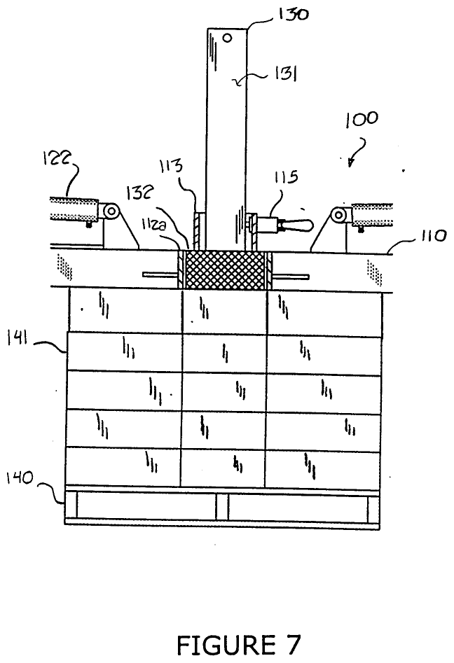

The internal support 130 is an elongated member which is supported by the frame 110 so as to be able to translate vertically with respect to the frame 110. FIGS. 1 and 2 illustrate the internal support 130 in a lowered position with respect to the frame 110, and FIG. 6 illustrates the internal support 130 in a raised position. In the lowered position shown in FIGS. 1 and 2, the internal support 110 can be inserted into a cavity 142 in a load 141 to reinforce inner walls of the cavity 142, and in the raised position shown in FIG. 6, the lower end of the internal support 130 can be withdrawn mostly or entirely into the opening 112 in the frame 110.

The clamping apparatus 100 includes a guide portion 113 for guiding the internal support 130 for vertical movement with respect to the frame 110. The guide portion 113 may form part of the box-shaped member 112a defining the opening 112 in the frame 110, but in the present embodiment, the guide portion 113 is formed by a length of steel tubing which sits atop the box-shaped member 112a. In the present embodiment, the guide portion 113 has a square horizontal cross-sectional shape, but the shape of the guide portion 113 is not restricted as long as it can guide the internal support 130 for vertical movement with respect to the frame 110 of the clamping apparatus 100. The guide portion 113 may include guide members, such as sliding or rolling guides, which contact the outer surface of the internal support 130 as it moves vertically with respect to the frame 110 and keep the internal support 130 vertically disposed as it translates. For example, as shown in FIGS. 3 and 4, plastic plates 114 having good sliding properties may be secured to the interior of the guide portion 113 for slidably guiding the internal support 130 as it undergoes vertical translation with respect to the frame 110.

The guide portion 113 preferably exerts sufficiently low resistance to vertical movement of the internal support 130 with respect to the frame 110 of the clamping apparatus 100 that the application to the internal support 130 of an upwardly directed force approximately equal to the weight of the internal support 130 is sufficient to slide the internal support 130 upwards with respect to the frame 110. In addition, the internal support 130 can preferably slide downwards with respect to the frame 110 under its own weight in response to gravity when there is no upwardly directed force being applied to the internal support 130 and it is not being held in a raised position.

The internal support 130 may have a constant cross-sectional shape over its height. Alternatively, in the present embodiment, the internal support 130 has an elongated body portion 131 and a bottom portion 132 which has larger horizontal cross-sectional dimensions than the body portion 131 and has outer horizontal cross-sectional dimensions smaller than the inner horizontal cross-sectional dimensions of a cavity 142 which is to be reinforced so that the bottom portion 132 can be easily inserted into a cavity 142.

The body portion 131 can have any horizontal cross-sectional shape which enables it to be guided by the guide portion 113 for vertical movement with respect to the frame 110. For example, the body portion 131 may be rod-shaped, cylindrical, or prismatic. In the present embodiment, the body portion 131 has a square horizontal cross-sectional shape.

The bottom portion 132 can have any horizontal cross-sectional shape which enables the bottom portion 132 to reinforce a cavity 142 in a load 141 into which the bottom portion 132 is to be inserted during use. As a cavity 142 in a load 141 frequently has a square or rectangular shape as viewed in plan, the bottom portion 132 will often have a square or rectangular horizontal cross-sectional shape. However, a bottom portion 132 having a horizontal cross-sectional shape which is not square or rectangular can also be employed. For example, a bottom portion 132 which is circular or elliptical as viewed in plan could be effectively employed to reinforce a cavity which is square or rectangular as viewed in plan. Alternatively, the shape of the bottom portion 132 as viewed in plan could be a polygon other than a square or rectangle.

The location of the internal support 130 with respect to the frame 110 as viewed in plan will depend upon the location of a cavity 142 in a load 141 into which the internal support 130 is to be inserted. If the cavity 142 is located at the geometric center of the load as viewed in plan, the internal support 130 will typically be located at the geometric center of the frame 110 as viewed in plan, i.e., midway between each pair of opposing clamping arms 120. If the cavity in a load is not at the geometric center of a load, the location of the internal support 130 on the frame 110 can be selected accordingly. In the present embodiment, the internal support 130 is disposed at the geometric center of the frame 110 as viewed in plan. The present embodiment has a single internal support 130, but it is possible for it to have multiple internal supports 130 if a load contains multiple cavities needing reinforcement.

The internal support 130 can be made of any materials strong enough to withstand the forces applied to it during operation of the clamping apparatus 100. It may be formed from a single material over its entire height, or different portions may be made of different materials. It may be solid or hollow, depending upon strength and weight requirements.

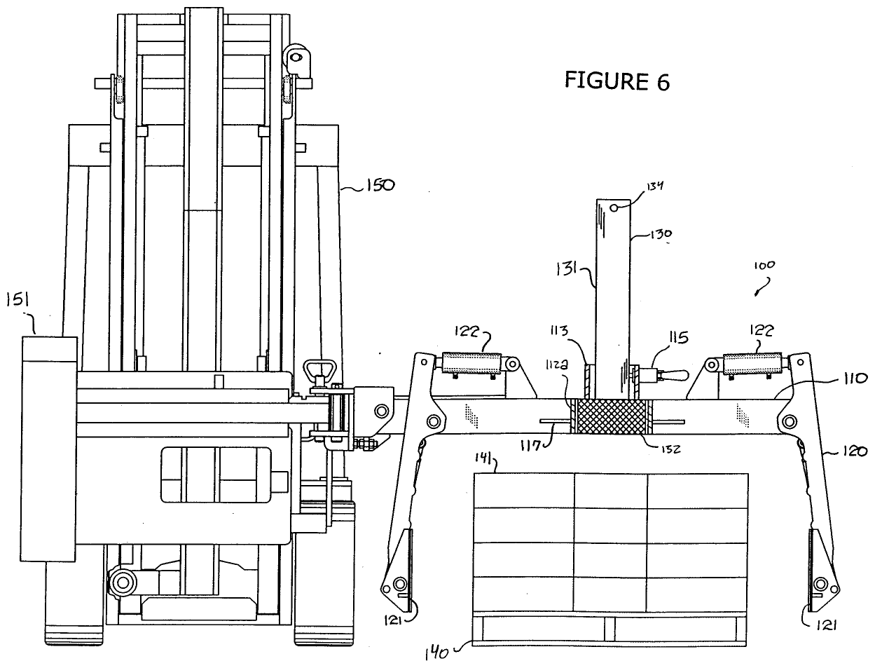

FIG. 5 is an exploded axonometric view showing one example of the structure of the internal support 130 in this embodiment. The body portion 131 and the bottom portion 132 are both formed from steel tubing having a square transverse cross-sectional shape measuring 5×5 inches. The longitudinal axis of the body portion 131 and the longitudinal axis of the bottom portion 132 are at right angles to each other. The lower end of the body portion 131 is secured to the top surface of the bottom portion 132 by welding, for example. A steel cap 136 is secured by welding, for example, to the open upper end of the tubing forming the body portion 131, and steel end plates 137 are secured by welding, for example, to the open ends of the tubing forming the bottom portion 132 of the internal support 130. In this example, the bottom portion measures roughly 10 inches long by 5 inches wide by 5 inches tall, while the body portion 131 has a length of approximately 34 inches.

The clamping apparatus 100 typically includes structure for limiting the range of downwards movement of the internal support 130 with respect to the frame 110 of the clamping apparatus 100. In the present embodiment, the internal support 130 is equipped with a removable pin 134 which can be detachably mounted in corresponding holes 133 formed in the body portion 131 of the internal support 130. The internal support 130 can translate downwards with respect to the frame 110 until the pin 134 rests atop the guide portion 113. When it is desired to remove the internal support 130 from the frame 110, the pin 134 can be removed from the internal support 130, and the body portion 131 of the internal support 130 can pass through the opening 112 in the frame 110 and be withdrawn from the frame 110. The pin 134 is strong enough to support the weight of the internal support 130 when the pin 134 is resting atop the guide portion 113. Structures other than a pin 134 can be used to limit the downwards movement of the internal support 130 with respect to the frame 110, such as a flange which is detachably secured to the exterior of the body portion 131 of the internal support 130 and which can support the weight of the internal support 130 while resting on the top of the guide portion 113 when the internal support 130 is in a lowered position.

The length of the body portion 131 of the internal support 130 is typically selected such when the pin 134 or other structure for limiting the downwards movement of the internal support 130 with respect to the frame is resting atop the guide portion 113, an imaginary horizontal line connecting the contact portions 121 of opposing clamping arms 120 when the contact portions 121 are contacting the outer surface of a load 141 passes through the bottom portion 132 of the internal support 130. In this manner, the bottom portion 132 can reinforce the inner walls of a cavity 142 in the load 141 against the forces applied to the load by the contact portions 121.

A material for increasing friction between the bottom portion 132 of the internal support 130 and the inner walls of a cavity in a load or for enabling the bottom portion 132 to grip inner walls of the cavity may be attached to some or all of the side surfaces of the bottom portion 132. When the objects in a load are plastic trays for soft drink bottles, an example of a suitable material for increasing friction is expanded metal mesh 138, sheets of which can be cut to a desired size and secured to some or all of the side surfaces of the bottom portion 132 by welding, for example. An example of a suitable expanded metal mesh is Model 9302T159 expanded steel panels available from McMaster-Carr. As shown in FIG. 5, in this embodiment, expanded metal mesh 138 is attached to the two lengthwise sides of the bottom portion 132, but it is also possible to attach an expanded metal mesh 138 to fewer or more than two side surfaces of the bottom portion 132, such as to all four side surfaces or to only the lengthwise ends of the bottom portion 132.

When the clamping apparatus 100 is being used to pick up a load 141 without a cavity 142 and the bottom portion 132 of the internal support 130 is resting on the top surface of the load, the weight of the internal support 130 effectively increases the weight of the load and increases the force which must be applied to the sides of the load by the clamping arms 120 to enable the clamping arms 120 to grip the load without slipping. In order to prevent the weight of the internal support 130 from being applied to the load, the clamping apparatus 100 may be equipped with a holding mechanism which holds the internal support 130 in a raised position with respect to the frame 110 of the clamping apparatus 100 so that the weight of the internal support 130 is applied to the frame 110 rather than to the load.

FIGS. 3 and 4 illustrate an example of a manually operated holding mechanism in the form of a conventional manually-operated toggle clamp 115 having a plunger 116 which can engage with a corresponding hole 135 (shown in FIG. 5) formed in the internal support 130 near the lower end of the body portion 131. There may be a single hole 135 for the plunger 116, or a plurality of holes 135 may be formed in the body portion 131 at different heights in order to enable the holding mechanism to hold the internal support 130 at multiple vertical positions with respect to the frame 110 of the clamping apparatus 100. As shown in FIGS. 3 and 4, the toggle clamp 115 is mounted on one of the side walls of the guide portion 113 with the plunger 116 of the toggle clamp 115 extending through the side wall and opposing a corresponding hole 135 in the internal support 130 when the internal support 130 is in a raised position. FIG. 3 shows the toggle clamp 115 with its plunger 116 extended to engage with a hole 135 (not visible in FIG. 3) in the internal support 130, thereby maintaining the internal support 130 in a raised position. FIG. 4 shows the toggle clamp 115 with its plunger 116 retracted and disengaged from the hole 135 in the internal support 130, thereby allowing the internal support 130 to translate vertically with respect to the frame 110. A holding mechanism for holding the internal support 130 in a raised position is not restricted to a toggle clamp, and any type of mechanism capable of securing the internal support 130 in a raised position with respect to the frame 110 can be employed. For example, a pin or rod could be inserted through aligned holes in the guide portion 113 of the frame 110 and the body portion 131 of the internal support 130. As another alternative, a holding mechanism could be a device which holds the internal support 130 in a raised position by pressing plungers, blocks, cams, teeth, brake shoes, etc. against the outer surface of the body portion 131 from multiple sides to frictionally engage the body portion 131. Instead of being manually-operated, the holding mechanism may be a powered device, such as an electrically, hydraulically, or pneumatically powered device, which an operator can operate remotely, such as from the operator's seat of a forklift.

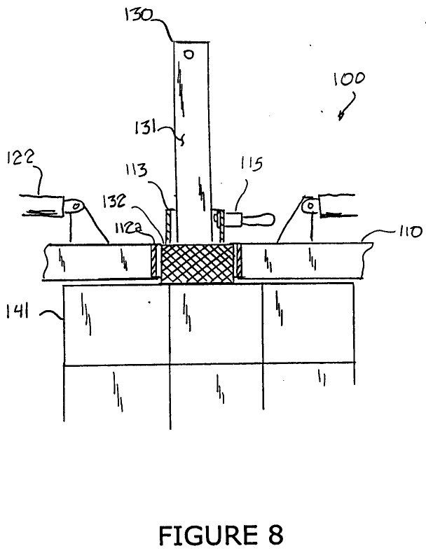

FIG. 7 shows an example in which the depth of the opening 112 in the frame 110 in the vertical direction is such that the internal support 130 can be raised to a position in which the bottom portion 132 of the internal support 130 is received within the opening 112 over the entire depth of the bottom portion 132. In this example, the lower end of the box-shaped member 112a which defines the opening 112 is flush with the bottom surface of the frame 110, and the internal support 130 can be raised to a height in which the bottom surface of the bottom portion 132 of the internal support 130 is also flush with the bottom surface of the frame 110. As a result, the clamping apparatus 100 can be lowered over a load 141 until the bottom surface of the frame 110 contacts the top surface of the load 141, so the internal support 130 does not limit the height of a load which can be grasped by the clamping apparatus 100.

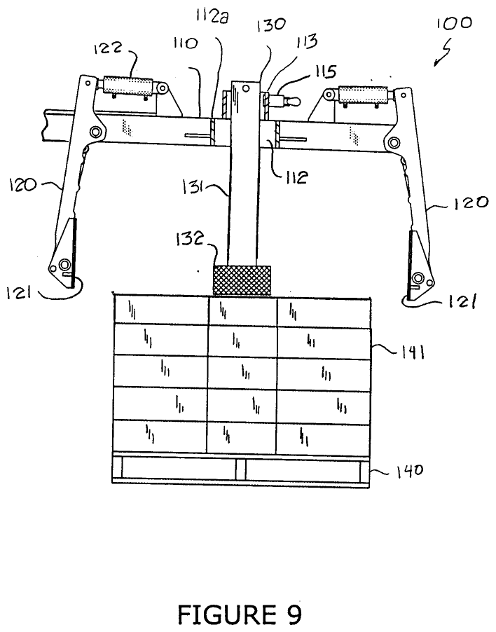

It is acceptable for the bottom portion 132 of the internal support 130 to extend outside of the opening 112 in the frame by a small amount when the internal support 130 is in a raised position as long as the amount by which the bottom portion 132 extends outside of the opening 112 does not unduly limit the height of a load which can be grasped by the clamping apparatus 100. FIG. 8 shows an example in which the depth of the bottom portion 132 of the internal support 130 is greater than the depth of the opening 112 in the frame 110. When the internal support 130 is raised until the top surface of the bottom portion 132 of the internal support 130 contacts the lower end of the guide portion 113 and the contact between the bottom portion 132 and the guide portion 113 prevents the internal support 130 from being raised any further with respect to the frame 110, the bottom portion 132 extends by a small amount below the lower surface of the frame 110. In general, the bottom portion 132 can extend below the bottom surface of the frame 110 by a small amount, such as by approximately 1 inch, without limiting the size of a load which can be grasped by the clamping apparatus 100. Depending upon the size of the load, it may be acceptable for the bottom portion 132 to extend below the bottom surface of the frame 110 by more than approximately one inch without interfering with the load. However, to maximize the size of a load which can be grasped by the clamping apparatus 100, the internal support 130 can preferably be raised to a position in which the bottom surface of the bottom portion 132 of the internal support 130 is flush with the bottom surface of the frame 110.

In the present embodiment, the shape of the opening 112 as viewed in plan generally resembles the shape of the outer surface of the bottom portion 132 of the internal support 130 as viewed in plan. For example, as shown in FIG. 3, in the present embodiment, the opening 112 and the bottom portion 132 both have a shape as viewed in plan which is an elongated rectangle. However, there is no restriction on the shape of the opening 112 as viewed in plan as long as the body portion 131 of the internal support 130 can pass through the opening 112 and the bottom portion 132 of the internal support 130 can be received inside the opening 112 around the entire periphery of the bottom portion 132.

When the internal support 130 is initially inserted into a cavity 142 in a load 141, there will usually be a gap between the outer peripheral surface of the bottom portion 132 and the inner walls of the cavity 142 to enable the bottom portion 132 to be easily inserted into the cavity 142. When the clamping arms 120 are pivoted with respect to the frame 110 to bring the contact portions 121 of the clamping arms 120 into contact with the outer surfaces of the load 141 in order to lift one or more layers of the load 141, items in the load 141 may shift towards the center of the cavity 142 and be pressed into contact with at least a portion of the outer peripheral surface of the bottom portion 132. When the clamping arms 120 subsequently release the load 141 and the clamping apparatus 100 is raised with respect to the load 141, the weight of the load 141 is sufficiently large that the internal support 130 can be easily withdrawn from the cavity 142 despite any frictional contact between the inner walls of the cavity 142 and the outer surface of the bottom portion 132 of the internal support 130.

FIG. 6 illustrates an example of how the clamping apparatus 100 can be mounted on a forklift 150. The clamping apparatus 100 is shown supported by a side shifter 151 which is mounted on the front of the mast of the forklift 150. The side shifter 151, which may be of conventional structure, is capable of translating the clamping apparatus 100 in the lateral direction of the forklift 150. Alternatively, the clamping apparatus 100 may be mounted on the front of the forklift 150 without using a side shifter. For example, the clamping apparatus 100 may be mounted directly on unillustrated forks of the forklift 150 in the manner shown in U.S. Pat. No. 7,993,094 entitled “Lift Truck”, the disclosure of which is incorporated by reference. The clamping apparatus 100 is shown connected to the side shifter 151 by a pivotal joint like one illustrated in U.S. Pat. No. 7,537,427 which enables the entire clamping apparatus 100 to be rotated about a vertical axis with respect to the side shifter 151, but the clamping apparatus 100 need not be pivotable with respect to a side shifter 151.

Instead of the bottom portion 132 of the internal support 130 being welded or otherwise permanently secured to the body portion 131 of the internal support 130, the bottom portion 132 may be detachably secured to the lower end of the body portion 131 to enable the bottom portion 132 to be replaced when desired. For example, a plurality of bottom portions 132 having different dimensions can be provided to accommodate loads having different sized cavities formed therein.

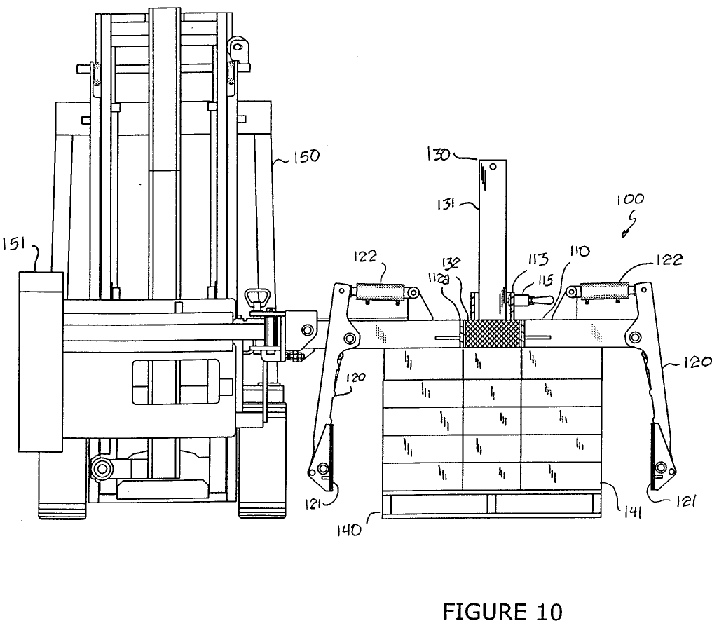

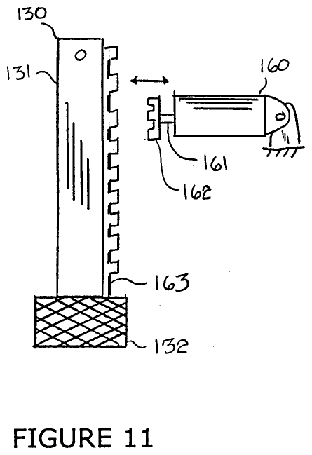

FIGS. 9 and 10 are schematic elevations of the clamping apparatus 100 illustrating an example of how the internal support 130 of the clamping apparatus 100 can be transitioned from a lowered position to a raised position with respect to the frame 110 of the clamping apparatus 100. As shown in FIG. 9, with the internal support 130 in a lowered position with respect to the frame 110 in which the removable pin 134 of the internal support 130 rests atop the guide portion 113, the clamping apparatus 100 can be positioned with the bottom surface of the bottom portion 132 of the internal support 130 contacting a solid surface, such as the top surface of a load 141 not having a cavity in its top surface. As shown in FIG. 10, with the clamping arms 120 in an open position, the clamping apparatus 100 can then be lowered over the load 141. The contact between the bottom surface of the bottom portion 132 and the top surface of the load 141 maintains the internal support 130 stationary as the clamping apparatus 100 is lowered, and due to the downwards movement of the frame 110 of the clamping apparatus 100, the internal support 130 undergoes relative vertical movement with respect to the frame 110 to a raised position with respect to the frame 110. FIG. 10 shows the clamping apparatus 100 lowered until the bottom surface of the frame 110 of the clamping apparatus 100 contacts the top surface of the load 141 and with the internal support 130 in a raised position in which the bottom portion 132 of the internal support 130 is flush with the bottom surface of the frame 110. In this state, the toggle clamp 115 or other holding mechanism can be operated, if desired, to hold the internal support 130 in a raised position.

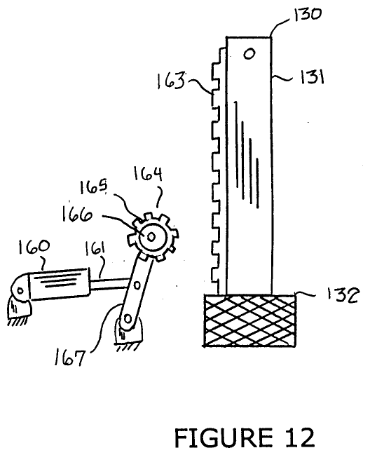

FIG. 11 illustrates an example of a holding mechanism which can hold the internal support 130 at a plurality of heights with respect to the frame 110 of the clamping apparatus 100. The holding mechanism includes an actuator 160 disposed adjoining the body portion 131 of the internal support 130. The actuator 160 includes a plunger 161 which can be advanced or retracted. Some examples of possible actuators for use in the holding mechanism are linear actuators such as solenoids, linear motors, hydraulic or pneumatic pistons, or rotary actuators connected to a motion converting mechanism which converts rotation of the actuator to linear movement of the plunger 161. A first engaging member such as a short first rack 162 is mounted on the outer end of the plunger 161 of the actuator 160, and a second engaging member such as an elongated second rack 163 is formed or mounted on the body portion 131 of the internal support 130 opposing the actuator 160. When the plunger 161 of the actuator 160 is advanced or retracted, the first rack 162 can be advanced to engage with the second rack 163 or retracted to disengage from the second rack 163. When the plunger 161 of the actuator 160 is advanced, the engagement between the first and second racks 162 and 163 locks the internal support 130 against downwards vertical movement with respect to the frame 110 of the clamping apparatus 100. When the plunger 161 of the actuator 160 is retracted, the first rack 162 is disengaged from the second rack 163, and the internal support 130 is able to translate vertically with respect to the frame 110 of the clamping apparatus 100. FIG. 11 shows only a single actuator 160, but a plurality of actuators 160 could be mounted on multiple sides of the internal support 130, with each actuator 160 having a short first rack 162 which can engage with a corresponding elongated second rack 163 mounted on the exterior of the body portion 131 of the internal support 130.

The first and second racks 162 and 163 in FIG. 11 could be replaced by other types of engaging members capable of undergoing positive engagement with each other, or they could be replaced by frictional materials which are mounted on the actuator 160 and the internal support 130 and which can frictionally engage with each other to hold the internal support 130 in a desired vertical position with respect to the frame 110 of the clamping apparatus 100. Some examples of suitable frictional materials are rubber, brake lining materials, or other materials having their opposing surfaces roughened to increase their coefficient of friction.

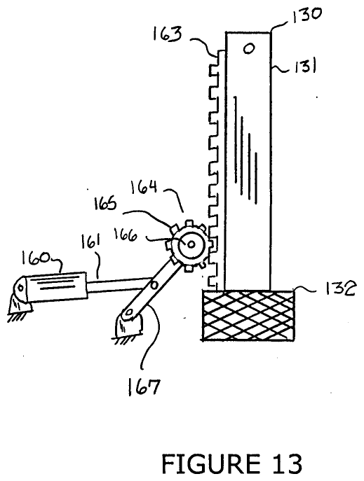

FIGS. 12 and 13 schematically illustrate another example of a holding mechanism for the internal support 130. In this example, as in the example shown in FIG. 11, an elongated rack 163 is mounted on the exterior of the body portion 131 of the internal support 130. A gear assembly 164 including a ring gear 165 and a one-way clutch 166 surrounded by the ring gear 165 is mounted on a lever 167 which can pivoted by an actuator 160 between a position shown in FIG. 12 in which the ring gear 165 is spaced from the rack 163 on the internal support 130 and an engaged position shown in FIG. 13 in which the ring gear 165 meshes with the rack 163. The one-way clutch 166 of the gear assembly 164 allows the ring gear 165 to rotate in the counterclockwise direction in FIGS. 12 and 13 but prevents it from rotating in the clockwise direction. When the ring gear 165 is engaged with the rack 163 as shown in FIG. 13, since the ring gear 165 is prevented by the one-way clutch 166 from rotating in the clockwise direction, the internal support 130 is prevented from moving downwards with respect to the frame 110 of the clamping apparatus 100 but is capable of being moved upwards. The ability of the internal support 130 to move upwards prevents the internal support 130 from damaging a load if the bottom portion 132 of the internal support 130 contacts a load when the clamping apparatus 100 is being lowered over a load. FIGS. 12 and 13 illustrate a single actuator 160 and gear assembly 164, but a plurality of similar actuators 160 and gear assemblies 164 can be disposed on multiple sides of the internal support 130, with each ring gear 165 able to engage with a corresponding rack 163 mounted on the internal support 130. Gear assemblies including a one-way clutch are widely used in starters for vehicles such as a motorcycles, for example, and such gear assemblies can be adapted for use in the present invention.

The holding mechanisms illustrated in FIGS. 3, 4, and 11-13 are not limited to use with an internal support 130 having the shape shown in FIGS. 1-10 or with respect to a clamping apparatus 100 having an opening 112 which can receive an internal support 130 over all or most of the lower end of the internal support 130. Rather, the holding mechanisms are generally applicable to use with a clamping apparatus having an internal support which can be raised and lowered with respect to a frame of the clamping apparatus.

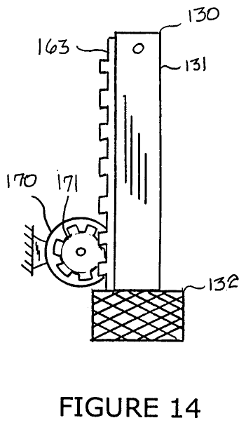

In order to prevent the internal support 130 from abruptly dropping from a raised position when the holding mechanism is released, the clamping apparatus 100 may include a damping mechanism for regulating the downwards movement of the internal support 130 when not being held by the holding mechanism. There are no restrictions on the structure of a damping mechanism. FIG. 14 illustrates an example of a damping mechanism which can be employed in a clamping apparatus according to the present invention. The damping mechanism in this example employs a conventional one-way rotary hydraulic damper 170 mounted next to the internal support 130. The damper 170 has a shaft which extends to the exterior of the damper 170 and on which an external gear 171 is mounted. The gear 171 meshes with a vertical rack 163 formed on the exterior of the body portion 131 of the internal support 130. As is standard with one-way hydraulic dampers, the shaft of the damper 170 has a first rotational direction in which the damper 170 exerts resistance to rotation of the shaft and a second rotational direction in which the damper 170 exerts little or no resistance to rotation of the shaft. In this example, the damper 170 exerts a greater resistance to rotation in the clockwise direction in FIG. 14 than to rotation in the counterclockwise direction so as to prevent a rapid descent of the internal support 130 with respect to the frame 110 of the clamping apparatus 100 while exerting little resistance to upwards movement of the internal support 130 with respect to the frame 110 of the clamping apparatus 100. The damper 170 can be mounted on any convenient portion of the clamping apparatus 100, such as on the guide portion 113. Suitable one-way rotary hydraulic dampers are widely available from multiple manufacturers.

Although FIG. 14 employs a single rotary damper 170, it is possible to employ two or more rotary dampers 170 mounted around the periphery of the internal support 130, with each rotary damper 170 engaging with a corresponding rack 163 on one of the sides of the internal support 130.

Instead of the rotary damper 170 having a gear 171 which engages with a rack 163 attached to the exterior of the internal support 130, the rotary damper 170 may be equipped with a roller which frictionally engages the outer surface of the internal support 130.

A damping mechanism for an internal support of a clamping apparatus is not limited to use with a clamping apparatus having the features shown in FIGS. 1-10 and is generally applicable for use with a clamping apparatus having an internal support which can be raised and lowered with respect to a frame of the clamping apparatus.

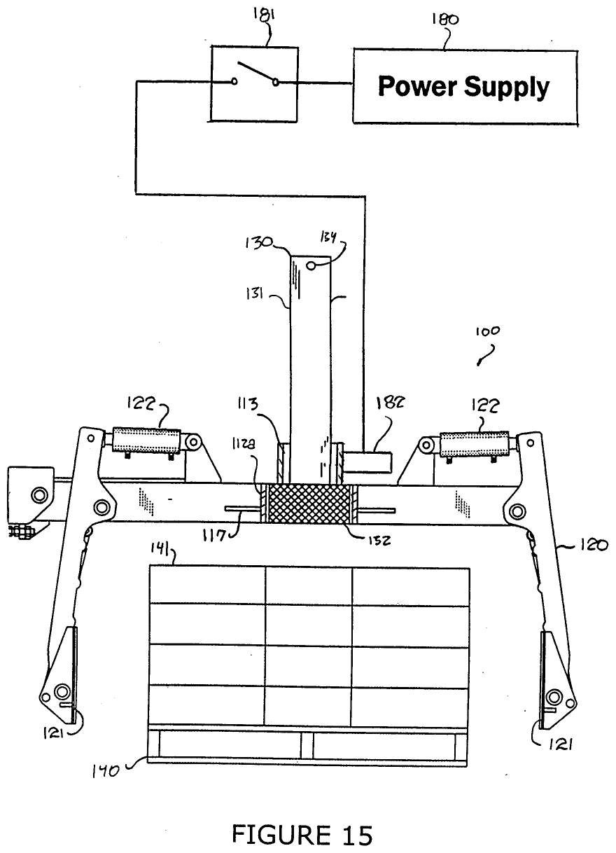

A holding mechanism which can be operated by the operator of the clamping apparatus 100 by remote control, such as the holding mechanisms shown in FIGS. 11-13, can be controlled in various ways. Some examples of possible control modes are described below with reference to FIGS. 15-18. These drawings are schematic in nature and are intended primarily to illustrate the concepts on which the methods by which a holding mechanism can be controlled are based and are not intended to limit the various control modes to the specific hardware shown in the drawings.

### On/Off Control of Holding Mechanism by Operator

In this mode of operation, the operator can activate or deactivate the holding mechanism at will to hold the internal support 130 against downwards vertical movement with respect to the frame 110 of the clamping apparatus 100 or release the internal support 130 to allow vertical movement of the internal support 130 with respect to the frame 110 of the clamping apparatus 100.

FIG. 15 conceptually illustrates an arrangement for performing this mode of control. A switch 181 which is operable by the operator of the clamping apparatus 100 is connected between an actuator 182 of the holding mechanism and a power supply 180 for the actuator 182. If the actuator 182 is an electrically powered device, such as a solenoid, the power supply 180 may be a battery or other source of electric power, and the switch 181 may be a single-pole, single-throw electrical switch, for example, having an open and a closed position. If the actuator 182 is a pneumatic or hydraulic actuator, the power supply 180 may be a source of compressed air or hydraulic fluid, and the switch 181 may be a valve operable by the user or an electrical switch which operates a valve. When the switch 181 is in a closed position, the actuator 182 is connected to the power supply 180 by the switch 181 and is energized so as to assume a state in which the holding mechanism holds the internal support 130 against downwards vertical movement with respect to the frame 110 of the clamping apparatus 100. When the switch 181 is in an open position, the actuator 182 does not receive power from the power supply 180 and assumes a state in which the holding mechanism does not hold the internal support 130 against downwards vertical movement with respect to the frame 110 of the clamping apparatus 100. For ease of illustration, the actuator 182 in the control arrangements shown in FIGS. 15-18 is assumed to be a monostable actuator (such as a monostable solenoid) which is maintained in an actuated state only so long as power is supplied to it and which automatically returns to an unactuated state when the supply of power to the actuator 182 is interrupted. However, it is also possible for the actuator 182 to be a bistable actuator (such as a bistable solenoid) which can maintain an actuated state without the continuous application of power to the actuator 182. Electronic circuits for controlling monostable or bistable actuators are well known to those skilled in the art, and any such circuits can be employed for controlling the actuator 182 in the present invention.

As stated above, the holding mechanism may be of a type which holds the internal support 130 against both upwards or downwards vertical movement with respect to the frame 110 of the clamping apparatus 100, or it may have a structure which can prevent downwards vertical movement of the internal support 130 while permitting upwards vertical movement of the internal support 130 with respect to the frame 110 of the clamping apparatus 100 as described above with respect to FIGS. 12 and 13. This manner of control can be employed with any of the above-described examples of holding mechanisms.

### Automated Control Based on Vertical Position of Internal Support

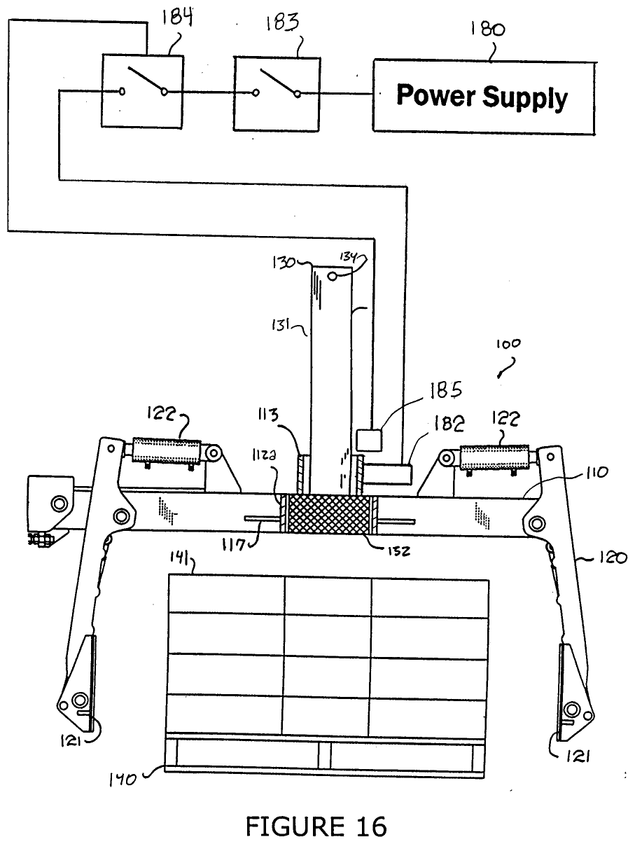

FIG. 16 conceptually illustrates an example of a control arrangement for automatically actuating a holding mechanism when the internal support 130 is in a prescribed vertical position with respect to the frame 110 of the clamping apparatus 100. A first switch 183 and a second switch 184 are connected in series between an actuator 182 and a power supply 180 to control the supply of power to the actuator 182. As in the previous control mode, the type of switches and the type of power supply 180 can be selected in accordance with the type of actuator 182.

The first switch 183, which may have the same structure as the switch 181 in FIG. 15, is a user-operated switch which can be switched by a user between an open position and a closed position. In the open position, no power is supplied to the second switch 184 from the power supply 180, and therefore no power is supplied to the actuator 182. In the closed position of the first switch 183, power from the power supply 180 is supplied to the second switch 184 through the first switch 183.

The second switch 184 is responsive to the vertical position of the internal support 130 with respect to the frame 110 of the clamping apparatus 100. The second switch 184 has an open position and a closed position. The second switch 184 is in the closed position when the internal support 130 is in a prescribed vertical position with respect to the frame 110 of the clamping apparatus 100 in which it is suitable for the holding mechanism to hold the internal support 130 against downwards vertical movement with respect to the frame 110 of the clamping apparatus 100. The second switch 184 is in the open position when the vertical position of the internal support 130 with respect to the frame 110 of the clamping apparatus 100 is other than the prescribed vertical position. An example of the prescribed vertical position of the internal support 130 is the raised position shown in FIG. 16 in which the bottom portion 132 of the internal support 130 is received within the opening 112 in the frame 110 of the clamping apparatus 100 over all or most of the depth of the bottom portion 132. When the second switch 184 is in the open position, the actuator 182 does not receive power from the power supply 180, so the holding mechanism is not actuated. When the second switch 184 is in the closed position, the actuator 182 receives power from the power supply 180, and the holding mechanism is activated to hold the internal support 130 against downwards vertical movement with respect to the frame 110 of the clamping apparatus 100 provided that the first switch 183 is in the closed position.

The second switch 184 can be a switch which directly senses the vertical position of the internal support 130 with respect to the frame 110 of the clamping apparatus 100. An example of a switch which directly senses the vertical position of the internal support 130 with respect to the frame 110 is a limit switch which is installed in the vicinity of the internal support 130, which is operated by contact with the internal support 130, and which closes when the internal support. 130 is in the prescribed vertical position but is otherwise open.

Alternatively, the clamping apparatus 100 may be equipped with a position sensor 185 which can sense the vertical position of the internal support 130 with respect to the frame 110 of the clamping apparatus 100 and particularly when the internal support 130 is in the prescribed vertical position and generate a corresponding output signal, and the second switch 184 can be an electrically controlled switch such as an electronic switch which is responsive to an electrical output signal from the position sensor 185. The position sensor 185 is not restricted to any particular type. To give a few non-limiting examples, it can be a limit switch, a proximity sensor, an encoder, or an optical sensor such as is commonly used with garage door openers to sense obstructions when the garage door is closing. With an optical sensor, a light emitter and a light sensor can be mounted on opposite sides of the internal support 130, and the internal support 130 can be equipped with an attachment which blocks a beam of light between the light emitter and the light sensor when the internal support 130 reaches the prescribed vertical position. The second switch 184 closes when the output signal from the position sensor 185 indicates that the internal support 130 is in the prescribed vertical position.

The first and second switches 183 and 184 may be discrete devices, or they may be incorporated into a single electronic circuit.

When the internal support 130 is being held in a raised position by the holding mechanism, the operator can release the internal support 130 from being held by the holding mechanism by switching the first switch 183 from the closed position to the open position, thereby cutting off the supply of power from the power supply 180 to the actuator 182 of the holding mechanism even if the second switch 184 is in a closed position. Once the internal support 130 moves downwards from the prescribed vertical position, the second switch 184 will open, and the switches 183 and 184 will return to the state illustrated in FIG. 16.

### Automated Control Based on the Position of the Clamping Arms

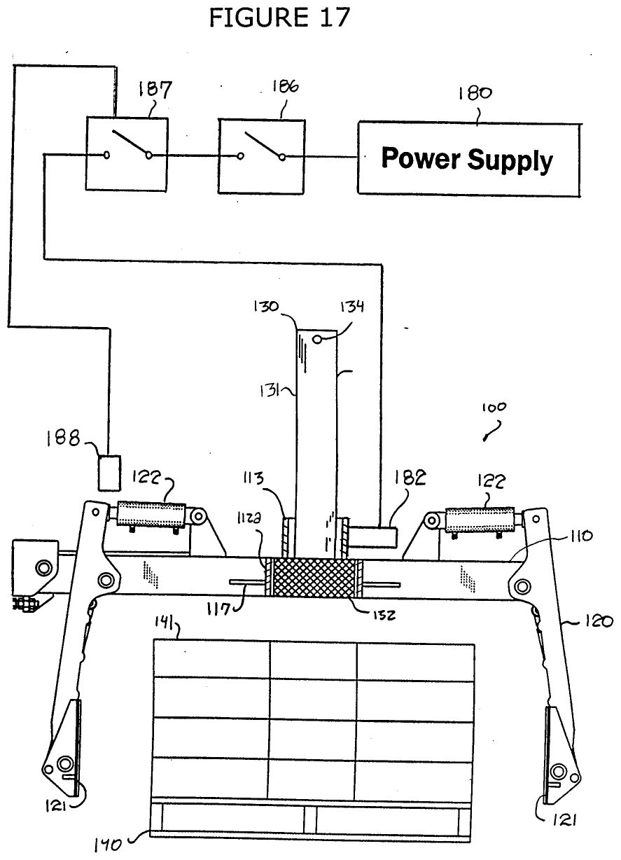

FIG. 17 conceptually illustrates an arrangement in which the actuator 182 of the holding mechanism is automatically operated based on the position of the clamping arms 120. This arrangement is similar to the arrangement of FIG. 16 in that it includes a first switch 186 and a second switch 187 connected in series between a power supply 180 and an actuator 182 of a holding mechanism. In contrast to the arrangement of FIG. 16 in which the second switch 184 is responsive to the vertical position of the internal support 130 with respect to the frame 110 of the clamping apparatus 100, the second switch 187 in the arrangement of FIG. 17 is responsive to the open or closed position of the clamping arms 120 of the clamping apparatus 100. The second switch 187 is in an open position when the clamping arms 120 are in an open position in which the clamping arms 120 are not grasping a load, and the second switch 187 is in a closed position when the clamping arms 120 are in a closed position in which the clamping arms 120 are grasping the sides of a load. The first switch 186 may have the same structure as the first switch 183 in FIG. 16.

The second switch 187 can be a switch which directly senses the open or closed position of the clamping arms 120. For example, the second switch 187 could be a limit switch which is mounted on the frame 110 of the clamping apparatus 100 and which is operated by contact with one of the clamping arms 120 and closes when the clamping arms 120 are closed. The second switch 187 could also be a limit switch mounted on one of the clamping arms 120 or on one of the hydraulic cylinders 122 for the clamping arms 120 and which switches between an open and closed position as the hydraulic cylinder 122 is retracted to open the clamping arms 120 or extended to close the clamping arms 120. When the clamping arms 120 are in an open position, the second switch 187 is likewise in an open position.

As an alternative, the clamping apparatus 100 may be equipped with a sensor 188 which can sense whether the clamping arms 120 are open or closed and produce a corresponding output signal, and the second switch 187 can be an electrically controlled switch such as an electronic switch which is responsive to the output signal from the sensor 188, with the second switch 187 opening when the output signal from the sensor 188 indicates that the clamping arms 120 are open and closing when the output signal indicates that the clamping arms 120 are closed. Examples of sensors capable of sensing the position of the clamping arms 120 and providing an output signal to the second switch 187 are a limit switch mounted on the frame 110 of the clamping apparatus 100 or on one of the hydraulic cylinders 122, a rotational angle sensor which senses the rotation of one of the clamping arms 120, or a hydraulic pressure sensor for sensing the hydraulic pressure which is supplied to one of the hydraulic cylinders 122 and which changes depending upon whether the hydraulic cylinder is being extended or retracted to advance or extended to close or open the clamping arms 120.

With the arrangement shown in FIG. 17, if the first switch 186 is in a closed position, the actuator 182 of the holding mechanism is automatically energized and the holding mechanism is automatically operated to hold the internal support 130 against downwards vertical movement with respect to the frame 110 of the clamping apparatus 100 whenever the clamping arms 120 of the clamping apparatus 100 are closed, which causes the second switch to be in a closed position. On the other hand, the second switch 187 opens to disconnect the actuator 182 from the power supply 180 and the holding mechanism releases the internal support 130 whenever the clamping arms 120 are in their open position. If the first switch 186 is in the open position, the holding mechanism is not operated regardless of whether the clamping arms 120 are in an open or closed position.

The arrangement shown in FIG. 17 is particularly suitable for use when the holding mechanism is of a type which is able to hold the internal support 130 at a plurality of heights with respect to the frame 110 of the clamping apparatus 100, such as the holding mechanisms schematically illustrated in FIGS. 11-13.

In FIGS. 16 and 17, the first switch 183 or 186 is shown being connected between the power supply 180 and the second switch 184 or 187, but the second switch 184 or 187 could instead be connected between the power supply 180 and the first switch 183 or 186.

Combined on/Off Control by Operator and Automated Control of Holding Mechanism

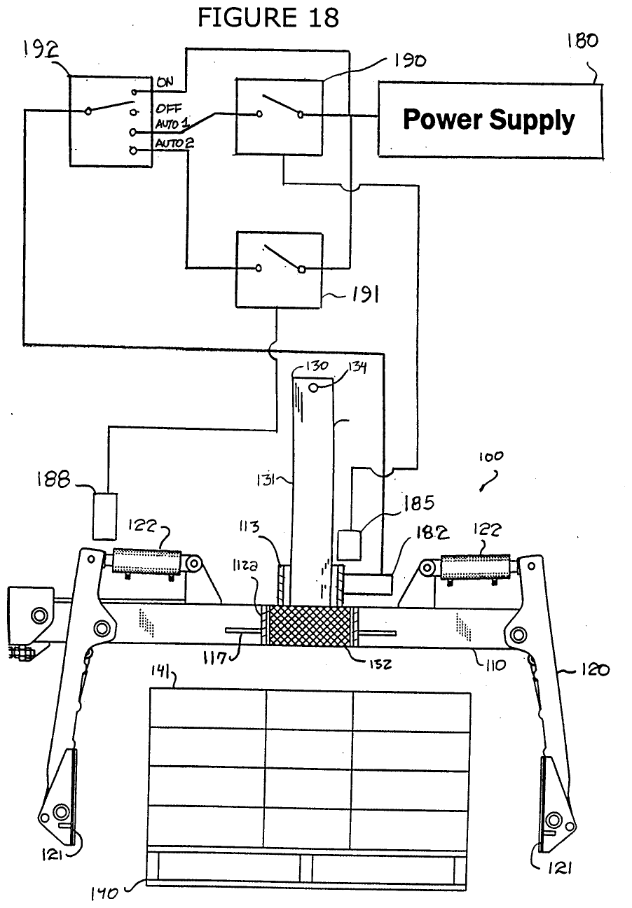

FIG. 18 conceptually illustrates an arrangement which combines the features of the arrangements shown in FIGS. 15-17 and enables an operator of the clamping apparatus 100 to select either manual control, automated control based on the vertical position of the internal support 130 with respect to the frame 110 of the clamping apparatus 100, or automated control based on the open or closed position of the clamping arms 120 of the clamping apparatus 100.

This arrangement includes a first switch 190, a second switch 191, and a third switch 192. The first switch 190, which may be the same as the second switch 184 of FIG. 16, is responsive to the vertical position of the internal support 130 with respect to the frame 110 of the clamping apparatus 100. Like the second switch 184 in FIG. 16, the first switch 190 may be a switch which itself senses the vertical position of the internal support 130 with respect to the frame 110, or the clamping apparatus 100 may be equipped with a position sensor 185 which senses the vertical position of the internal support 130 with respect to the frame 110 and generates a corresponding output signal, and the first switch 190 may be a switch, such as an electronic switch, which operates in response to the output signal from the position sensor 185. The first switch 190 has an input terminal which is connected to a power supply 180 and an output terminal. The first switch 190 is in a closed state when the internal support 130 is in a prescribed vertical position with respect to the frame 110 of the clamping apparatus 100 in which it is suitable for the holding mechanism to hold the internal support 130 against downwards vertical movement with respect to the frame 110 of the clamping apparatus 100. At other times, the first switch 190 is in an open state.

The second switch 191, which may be the same as the second switch 187 in FIG. 17, is responsive to the position of the clamping arms 120 of the clamping apparatus 100. It has an input terminal which is connected to the power supply 180 and an output terminal. The second switch 191 is in an open state when the clamping arms 120 are in an open state in which the clamping arms 120 are not grasping a load, and it is in a closed state when the clamping arms 120 are in a closed state in which the clamping arms 120 are grasping the sides of a load. Like the second switch 187 in FIG. 17, the second switch 191 may be a switch (such as a limit switch) which itself senses the open or closed position of the clamping arms 120, or the clamping apparatus 100 may be equipped with a sensor 188 which senses the open or close position of the clamping arms 120 and generates a corresponding output signal, and the second switch 191 may be a switch, such as an electronic switch, which operates in response to the output signal from the sensor 188, closing when the output signal indicates that the clamping arms 120 are in a closed position and opening when the output signal indicates that the clamping arms 120 are in an open position.

The third switch 192, which can be a mechanical switch or an electronic switch, is a selector switch which can be switched between four different settings. It has an output terminal connected to an actuator 182 of the holding mechanism and four input terminals. A first input terminal (labeled as ON in FIG. 18) is connected to the power supply 180, a second input terminal (labeled as OFF) is not connected to any other member, a third input terminal (labeled as AUTO 1) is connected to the output terminal of the first switch 190, and a fourth input terminal (labeled as AUTO 2) is connected to the output terminal of the second switch 191. The third switch 192 has an on setting in which the output terminal of the third switch 192 is internally connected to the first input terminal (ON), an off setting in which the output terminal of the third switch 192 is internally connected to the second input terminal (OFF), a first automated setting in which the output terminal of the third switch 192 is internally connected to the third input terminal (AUTO 1), and a second automated setting in which the output terminal of the third switch 192 is internally connected to the fourth input terminal (AUTO 2).

The first through third switches 190-192 may be discrete devices, or they may be incorporated into a single electronic circuit.

When the third switch 192 is in the first automated setting, the control arrangement operates in the same manner as the control arrangement shown in FIG. 16. Namely, when the vertical position of the internal support 130 with respect to the frame 110 of the clamping apparatus 100 is other than the prescribed vertical position, the first switch 190 is in the open state, and the actuator 182 of the holding mechanism does not receive power from the power supply 180. On the other hand, when the internal support 130 is in the prescribed vertical position, the first switch 190 is in the closed state, the actuator 182 of the holding mechanism receives power from the power supply 180 through the first switch 190, and the holding mechanism is activated to hold the internal support 130 in the prescribed vertical position against downwards vertical movement with respect to the frame 110 of the clamping apparatus 100.

When the third switch 192 is in the second automated setting, the control arrangement operates in the same manner as the arrangement shown in FIG. 17. Namely, when the clamping arms 120 of the clamping apparatus are in an open state, the second switch 191 is in an open state in which the actuator 182 of the holding mechanism does not receive power from the power supply 180, and the holding mechanism does not hold the internal support 130 against downwards vertical movement with respect to the frame 110 of the clamping apparatus 100. On the other hand, when the clamping arms 120 are in a closed state, the second switch 191 is in its closed state, the actuator 182 of the holding mechanism receives power from the power supply 180 through the second switch 191, and the holding mechanism is activated to hold the internal support 130 against downwards vertical movement with respect to the frame 110 of the clamping apparatus 100.

When the third switch 192 is in the on setting, the actuator 182 of the holding mechanism receives power from the power supply 180 through the third switch 192, and the actuator 182 of the holding mechanism is operated to hold the internal support 130 against downwards vertical movement with respect to the frame 110 of the clamping apparatus 100 regardless of the state of the first switch 190 or the second switch 191.

In addition, when the third switch 192 is in the off setting, the actuator 182 of the holding mechanism is disconnected from the power supply 180, so the actuator 182 of the holding mechanism is in an off state, and the holding mechanism does not hold the internal support 130 against downwards vertical movement.

The circuitry conceptually illustrated in FIGS. 15-18 can be implemented by individual components, but it can also be implemented by an electronic control unit which receives input signals from one or more sensors 185 and 188 and from a user-operated input device employing buttons, switches, a touch screen, or the like to enable a user to select the operating mode of the control arrangement.

The control arrangements described with respect to FIGS. 15-18 are not limited to use with a clamping apparatus having the features shown in FIGS. 1-10. Rather, they generally applicable to use with a clamping apparatus having an internal support which can be raised and lowered with respect to a frame of the clamping apparatus and a holding mechanism capable of holding the internal support against downwards movement with respect to the frame of the clamping apparatus.

The horizontal cross-sectional dimensions of the bottom portion 132 of the internal support 130 may be selected such that the bottom portion 132 can reinforce all sides (typically 4 sides) of a cavity in a load into which the internal support 130 is inserted. However, depending upon the arrangement of objects in the load, it may be sufficient for the bottom portion 132 to reinforce fewer than all sides of the cavity.

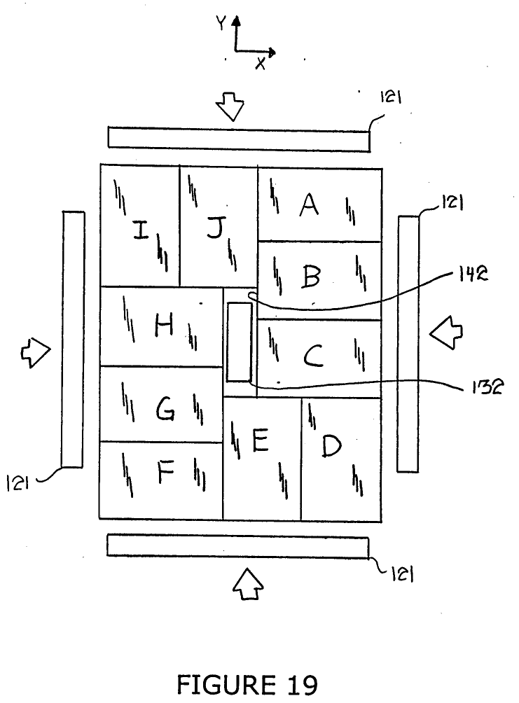

FIG. 19 schematically illustrates an example of a common arrangement of trays of soft drink bottles disposed in a layer on a pallet. The illustrated layer comprises ten trays labeled A-J surrounding an elongated rectangular cavity 142. When the layer is being grasped by the clamping arms 120 of the clamping apparatus 100, the contact portions 121 of the clamping arms 120 apply compressive forces (indicated by hollow arrows in the figure) to the outer surfaces of the layer in the x-axis direction and the y-axis direction. On account of the overlap in the x-axis direction between adjacent trays, the presence of the cavity 142 in the layer does not result in any shifting of the trays within the layer under compressive forces applied in the y-axis direction. In contrast, the left-hand side of tray C and the right-hand side of tray H, which both adjoin the cavity 142 over their entire length, are not reinforced against compressive forces in the x-axis direction applied to the layer by the clamping arms 120. Therefore, the width of the bottom portion 132 of the internal support 130 is selected to be close to the width of the cavity 142 in the x-axis direction to reinforce the two side walls of the cavity 142 adjoining trays C and H. On the other hand, since the layer can resist the application of compressive forces by the clamping arms 120 in the y-axis direction, it is unnecessary for the lengthwise ends of the bottom portion 132 to contact the lengthwise ends of the cavity 142 (the upper and lower ends in the y-axis direction in FIG. 19), and the length of the bottom portion 132 of the internal support 130 in the y-axis direction can be selected entirely based on providing sufficient support to the cavity 142 against compressive forces applied in the x-axis direction. To give an example, for trays measuring 12.5×19 inches and a cavity 142 in FIG. 19 measuring 5.375×18.375 inches, an internal support 130 having a bottom portion 132 measuring 5×10 inches is sufficient to support the cavity 142 against compressive forces when the layer is being grasped by the clamping apparatus 100. When the lengthwise ends of the bottom portion 132 of the internal support 130 in FIG. 19 do not need to contact the lengthwise ends of the cavity 142 in the y-axis direction in the figure, a frictional material such as an expanded metal mesh 138 can be omitted from the lengthwise ends of the bottom portion 132, as shown in FIG. 5.

In the preceding embodiments, the internal support 130 is slidably supported by the frame 110 of the clamping apparatus 100 so that the internal support 130 can freely move upwards with respect to the frame 110 in response to the application of an upwardly directed external force to the internal support 130 and so that it can slide downwards with respect to the frame 110 under its own weight in response to gravity to a lowered position when there is no upwardly directed external force applied to the internal support 130 and it is not being held in place by a holding mechanism or its downwards movement is being otherwise blocked.

However, it is also possible to raise and lower the internal support 130 with respect to the frame 110 of the clamping apparatus 100 with a powered lifting mechanism.

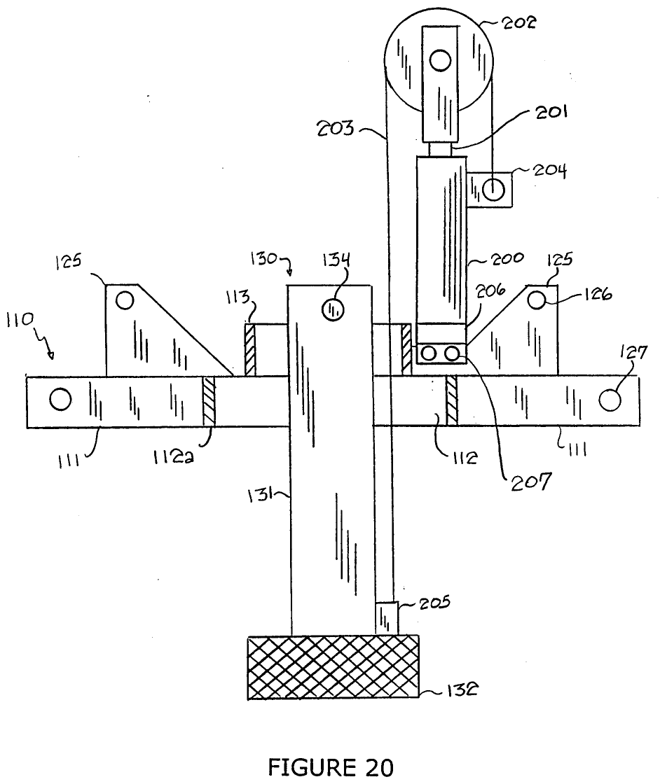

FIG. 20 is a schematic cutaway illustration of an example of an arrangement for raising and lowering the internal support 130 with a powered lifting mechanism. FIG. 20 shows the frame 110 and the internal support 130 of the clamping apparatus 100, but various other components of the clamping apparatus 100 have been omitted from FIG. 20 for clarity, including the clamping arms 120, the hydraulic cylinders 122 for operating the clamping arms 120, a holding mechanism for releasably holding the internal support 130, and a control arrangement for a holding mechanism.

As shown in FIG. 20, the legs 111 of the frame 110 of the clamping apparatus 100 include holes 127 for pivotably mounting the clamping arms 120 on the frame 110, and cylinder mounting brackets 125 for supporting the hydraulic cylinders 122 are secured to the tops of the legs 111 of the frame 1120. Each of the cylinder mounting brackets 125 includes a hole 126 in which one of the hydraulic cylinders 122 can be pivotably mounted.

An actuator in the form of a hydraulic cylinder 200 is rigidly mounted atop the frame 110 of the clamping apparatus 100 with the longitudinal axis of the hydraulic cylinder 200 extending vertically. For example, in FIG. 20, a clevis 206 is secured to the lower end of the hydraulic cylinder 200 by welding, for example, and the clevis 206 is detachably secured to the right-hand cylinder mounting bracket 125 in the figure by clevis pins 207. A rotatable direction changing member 202 such as a cable sheave, a chain sheave, or a roller is rotatably mounted atop a piston rod 201 of the hydraulic cylinder 200, and a tension member 203 such as a cable, a chain, or a belt extends around the rotatable member 202. A first end of the tension member 203 is secured to a location which remains stationary with respect to the frame 110 of the clamping apparatus 100 as the internal support 130 moves up and down with respect to the frame 110, and a second end of the tension member 203 is secured to the internal support 130. In this example, the first end of the tension member 203 is secured to an anchor 204 such as a lug mounted on the housing of the hydraulic cylinder 200, and the second end of the tension member 203 is secured to another anchor 205 such as a lug secured to the lower end of the body portion 131 and/or to the bottom portion 132 of the internal support 130. The hydraulic cylinder 200 can be driven by an unillustrated source of hydraulic fluid to extend or retract the piston rod 201. For example, when the clamping apparatus 100 is mounted on a forklift, the hydraulic cylinder 200 can be powered by the hydraulic system of the forklift. When the piston rod 201 of the hydraulic cylinder 200 is extended by the hydraulic cylinder 200 to raise the rotatable member 202, the internal support 130 is lifted by the tension member 203 with respect to the frame 110 of the clamping apparatus 100, and when the piston rod 201 is retracted by the hydraulic cylinder 200, the internal support 130 travels downwards with respect to the frame 110 of the clamping apparatus 100 under the force of gravity, with the rate of descent of the internal support 130 being controlled by the hydraulic cylinder 200 through the tension member 203. The anchor 205 secured to the second end of the tension member 203 preferably has a size such that it can be raised into the space between the outer surface of the body portion 131 of the internal support 130 and the inner surface of the guide portion 113 so that the bottom portion 132 of the internal support 132 can be received in the opening 112 in the frame 110 of the clamping apparatus 100 over all or most of the depth of the bottom portion 132. Alternatively, if the anchor 205 is too large to fit inside the space between the outer surface of the internal support 130 and the inner surface of the guide portion 113, a slot for receiving the anchor 205 can be formed in the guide portion 113 so that the anchor 205 will not limit how far the bottom portion 132 can enter into the opening 112 in the frame 110 of the clamping apparatus 100.

With the arrangement shown in FIG. 20, the internal support 130 can be raised and lowered with respect to the frame 110 of the clamping apparatus 100 by twice the stroke of the hydraulic cylinder 200. For example, when the hydraulic cylinder 200 has a stroke of 12.5 inches, the internal support 130 can be raised and lowered with respect to the frame 110 of the clamping apparatus 100 by 25 inches.

Drive mechanisms other than a hydraulic cylinder 200 can be used to raise and lower the internal support 130, such as linear motors or pneumatic cylinders. As another alternative, a tension member 203 could be secured to a rotating member such as a sheave or a roller rotatably supported by the frame 110 of the clamping apparatus 100 at a fixed height with respect to the frame 110, and the rotating member could be rotationally driven by a motor. As the rotating member is rotationally driven, the tension member 203 is wound around or unwound from the rotating member to raise or lower the internal support 130. As still another alternative, the internal support 130 could be raised and lowered by a motor-driven gear engaging with an elongated rack on the exterior of the body portion of the internal support 130. Thus, a variety of structures can be used to raise and lower the internal support 130 with respect to the frame 110 of the clamping apparatus 100.

What is claimed is:

1. A clamping apparatus comprising:
a frame;
a plurality of clamping arms supported by the frame for movement into and out of contact with a load to be lifted; and
an internal support for insertion into a cavity in the load to be lifted, the internal support being mounted on the frame between the clamping arms for vertical translation with respect to the frame in a lengthwise direction of the internal support, wherein the internal support includes an elongated body portion which is guided by the frame and a bottom portion having larger horizontal cross-sectional dimensions than the body portion, and the internal support can be raised with respect to the frame to a position in which the bottom portion of the internal support is received within an opening in the frame over all or most of the depth of the bottom portion.

2. A clamping apparatus as claimed in claim 1 wherein the internal support can be raised with respect to the frame to a position in which the bottom portion of the internal support is received within the opening in the frame over the entire depth of the bottom portion.

3. A clamping apparatus as claimed in claim 1 including a holding mechanism configured to hold the internal support in a raised position with respect to the frame with the bottom portion of the internal support received within the opening.

4. A clamping apparatus as claimed in claim 1 including a frictional material secured to an outer surface of the bottom portion of the internal support for increasing friction between the outer surface of the bottom portion and an inner surface of the cavity.

5. A clamping apparatus as claimed in claim 4 wherein the frictional material comprises an expanded metal mesh.

6. A clamping apparatus as claimed in claim 1 including a lifting mechanism mounted on the frame and connected to the internal support to raise and lower the internal support with respect to the frame.

7. A clamping apparatus comprising:
a frame;
a plurality of clamping arms supported by the frame for movement into and out of contact with a load to be lifted;
an internal support for insertion into a cavity in the load, the internal support being mounted on the frame between the clamping arms for vertical translation with respect to the frame; and
a holding mechanism which can releasably hold the internal support in a raised position with respect to the frame.

8. A clamping apparatus as claimed in claim 7 including a damping mechanism for damping downwards movement of the internal support with respect to the frame when the internal support is not held by the holding mechanism.

9. A clamping apparatus as claimed in claim 8 wherein the damping mechanism comprises a rotary hydraulic damper engaged with the internal support.

10. A clamping apparatus as claimed in claim 7 wherein the holding mechanism automatically holds the internal support against downwards vertical movement with respect to the frame when the internal support is at a prescribed vertical position with respect to the frame in which a lower end of the internal support is mostly or entirely received inside an opening in the frame.

11. A clamping apparatus as claimed in claim 7 wherein the holding mechanism automatically holds the internal support against downwards vertical movement with respect to the frame when the clamping arms are in a closed position and automatically releases the internal support when the clamping arms are in an open position.

12. A clamping apparatus as claimed in claim 7 wherein the holding mechanism prevents downwards vertical movement of the internal support with respect to the frame while permitting upwards vertical movement of the internal support with respect to the frame.

13. A method of operating a clamping apparatus comprising:
disposing the clamping apparatus of claim 7 above a load;
lowering the clamping apparatus with respect to the load with a lower end of the internal support contacting a top surface of the load to cause the internal support to translate upwards relative to the frame of the clamping apparatus; and
automatically operating the holding mechanism to hold the internal support against downwards vertical movement with respect to the frame when the internal support reaches a prescribed vertical position with respect to the frame in which the lower end of the internal support is mostly or entirely received inside an opening in the frame of the clamping apparatus.

14. A method as claimed in claim 13 including sensing a position of the internal support with respect to the frame with a sensor and automatically operating the holding mechanism to hold the internal support against downwards vertical movement with respect to the frame when the sensor senses that the internal support is in the prescribed vertical position with respect to the frame.

15. A method of operating a clamping apparatus comprising:
lowering the clamping apparatus of claim 7 over a load with the clamping arms in an open position;
moving the clamping arms to a closed position to grasp the load with the clamping arms; and
automatically operating the holding mechanism to hold the internal support against downwards vertical movement with respect to the frame of the clamping apparatus when the clamping arms are in the closed position.

16. A method as claimed in claim 15 including sensing with a sensor whether the clamping arms are in the open or closed position of the clamping arms and automatically operating the holding mechanism to hold the internal support against downwards vertical movement with respect to the frame when the sensor senses that the clamping arms are in the closed position.

17. A method as claimed in claim 16 including automatically releasing the internal support with the holding mechanism when the sensor senses that the clamping arms are in the open position.
